(19) United States
(12) Patent Application Publication
(10) Pub. No.: US 2012/0304523 A1
(43) Pub. Date: Dec. 6, 2012

(54) FISH LURE

(76) Inventor: David Haldin, Maple Ridge (CA)

(21) Appl. No.: 13/312,970

(22) Filed: Dec. 6, 2011

Related U.S. Application Data
(60) Provisional application No. 61/420,762, filed on Dec. 7, 2010.

(51) Int. Cl. A01K 85/00; A01K 99/00

(52) U.S. Cl. 43/42; 43/42.53

(57) ABSTRACT

A fishing lure is made of a heat-moldable material. A person can warm the lure and then form the lure to have a desired shape. The lure holds its shape after it has cooled. In some embodiments material of the lure body is transparent and the lure includes a sheet of graphics which can be seen when the lure body is observed.

### CROSS REFERENCE TO RELATED APPLICATION

This application claims the benefit under 35 U.S.C. §119 of U.S. Patent Application No. 61/420,762 filed on 7 Dec. 2010 entitled FISH LURE.

### TECHNICAL FIELD

This invention relates to lures for use in fishing and related methods.

### BACKGROUND

Fishing is an activity enjoyed by a wide range of people. Fishing is pursued for enjoyment, livelihood, and sustenance. A successful lure attracts fish to attack the lure. Fish respond to factors such as the appearance of a lure, the way the lure moves through the water, and vibrations in the water made by the passage of the lure. The tastes of fish are different from time to time and place to place. People who fish typically have a wide assortment of lures. It is a challenge to select a lure that will attract fish at the time and in the place where they are fishing.

### SUMMARY

Further aspects of the invention and features of a range of example embodiments are discussed below and illustrated in the accompanying drawings.

### BRIEF DESCRIPTION OF DRAWINGS

Exemplary embodiments are illustrated in referenced figures of the drawings. The embodiments and figures disclosed herein are intended to be illustrative and not restrictive.

FIG. 1 is a perspective view of a fish lure according to an example embodiment of the invention.

FIG. 2 is a cross section of the lure of FIG. 1 in the plane 2-2.

FIGS. 2A through 2B illustrate an example manner of use of the fish lure.

FIG. 3 illustrates a method for forming the fish lure to have a desired configuration.

FIG. 4 is a flowchart illustrating a method for making a lure of the type shown in FIG. 1.

FIGS. 4A through 4G illustrate intermediate stages in an example method for manufacturing a fish lure like that shown in FIG. 1.

FIGS. 5A through 5E illustrate various alternative ways in which a fish lure as shown in FIG. 1 may be shaped by a user.

FIG. 6 is a perspective view of a fish lure according to an example embodiment of the invention.

### DESCRIPTION

Throughout the following description specific details are set forth in order to provide a more thorough understanding to persons skilled in the art. However, well known elements may not have been shown or described in detail to avoid unnecessarily obscuring the disclosure. Accordingly, the description and drawings are to be regarded in an illustrative, rather than a restrictive, sense.

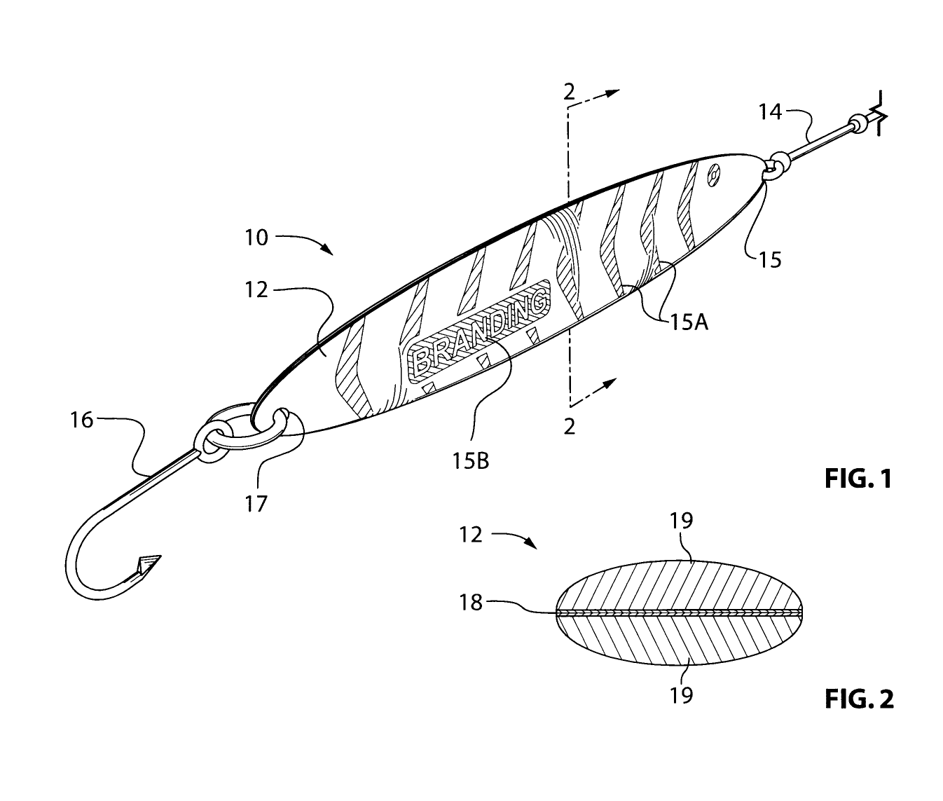

FIG. 1 shows a fish lure 10 according to an example embodiment. Fish lure 10 has a flattened body 12. A leader 14 is attached at an attachment point 15 at one end of body 12 and a hook 16 is attached at an attachment point 17 at another end of body 12.

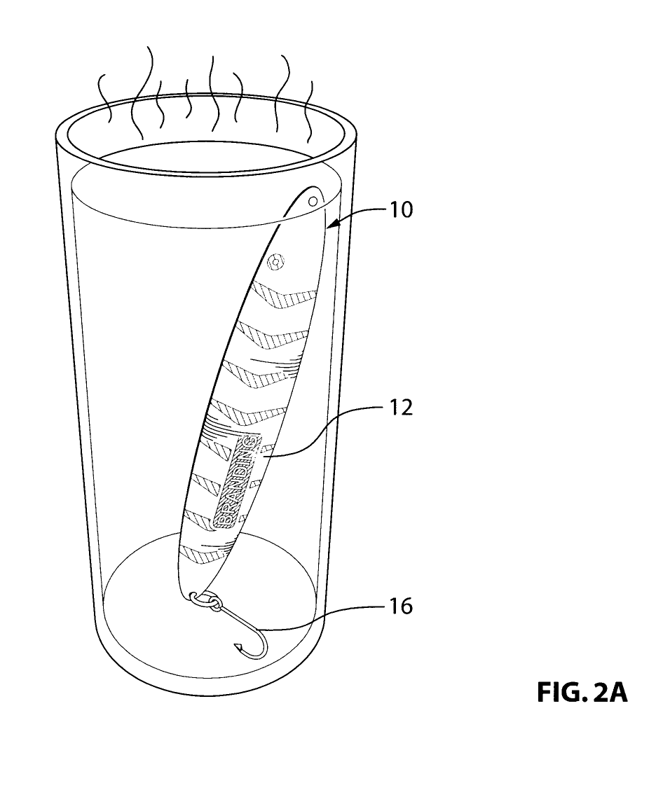

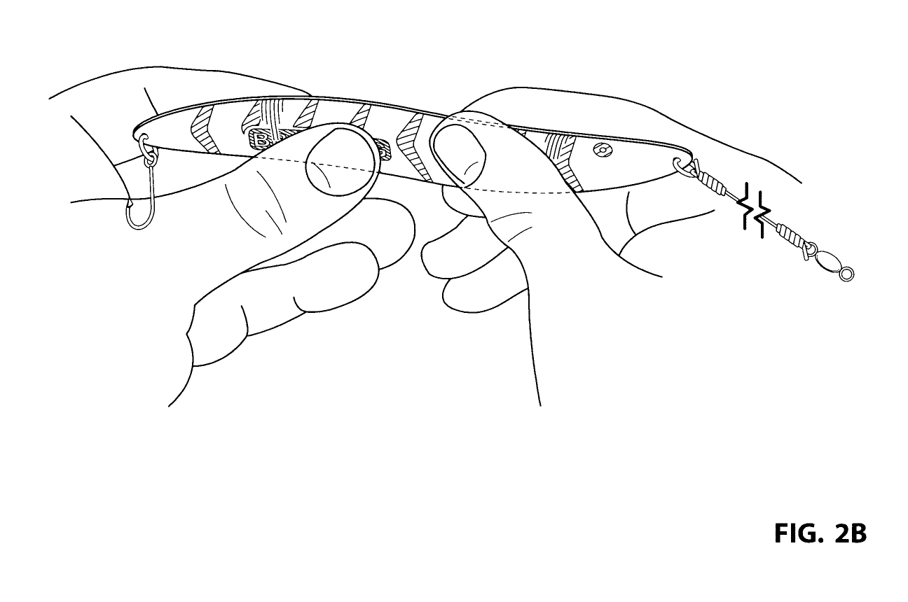

In the illustrated embodiment, body 12 comprises a central sheet 18 (see FIG. 2) coated on each face with a layer of a material 19 which gives body 12 some thickness. In an example embodiment, body 12 has a thickness of approximately 1/16 to 3/16 inches, a length of about 2 to 4 inches, and a height of about 1 to 2 inches.

In some embodiments, sheet 18 has indicia marked on it and material 19 is transparent so that those indicia can be seen when body 12 is observed. In the illustrated embodiment the indicia includes patterning 15A and branding 15B. In some embodiments, each face of sheet 18 comprises a shiny material such as a hologram material, a metal foil, an embossed foil, a laser-engraved aluminized surface, or the like. Fish tend to be attracted to shiny lures.

As shown in FIGS. 2A and 2B, material 19 has the property that it becomes malleable at a temperature somewhat above normal room temperature but holds its shape at lower temperatures such as the temperature of water in which the lure will be used for fishing. A user can warm body 12 for example by placing body 12 in hot or warm water; heating body 12 in the sun; or the like, until body 12 becomes malleable. Then, as illustrated in FIG. 2B, the user can shape body 12 to have a desired configuration. For example, the user may make one or more bends in body 12. The user can then let body 12 cool so that it retains the configuration that has been imparted to it. The user can then use lure 10 for fishing.

Body 12 may be molded and shaped in a wide range of ways that change its appearance as well as change the way it moves through the water and the vibrations it makes while moving through the water.

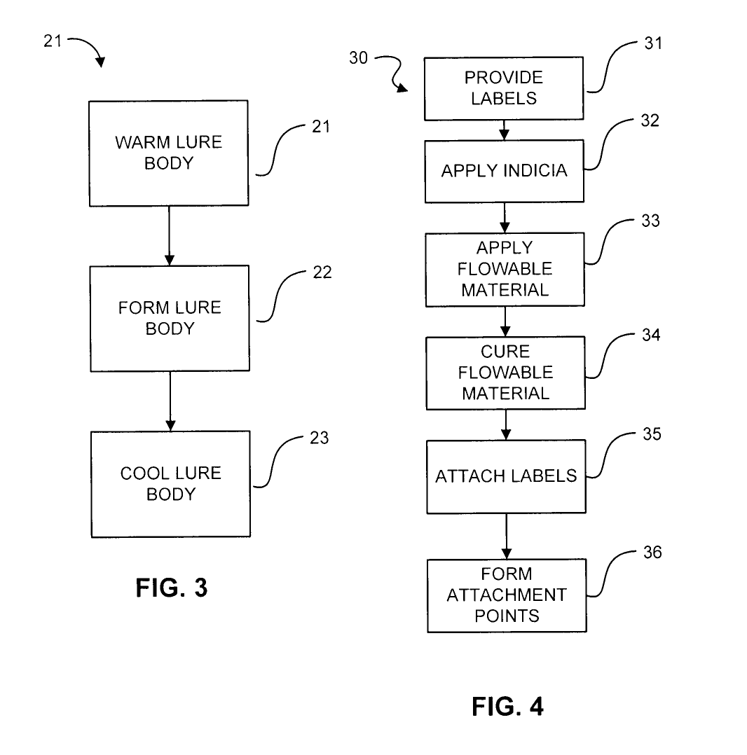

A method 20 for forming body 12 to provide a desired shape is illustrated in FIG. 3. Method 20 which comprises warming the body 12 of a lure 10 in block 21, forming the body 12 into a desired configuration in block 22, and allowing the body to cool so as to retain the imparted configuration in block 23. The lure 10 may subsequently be used for fishing in the usual way. In some embodiments, block 21 comprises heating body 12 to a temperature of 100° C. or lower.

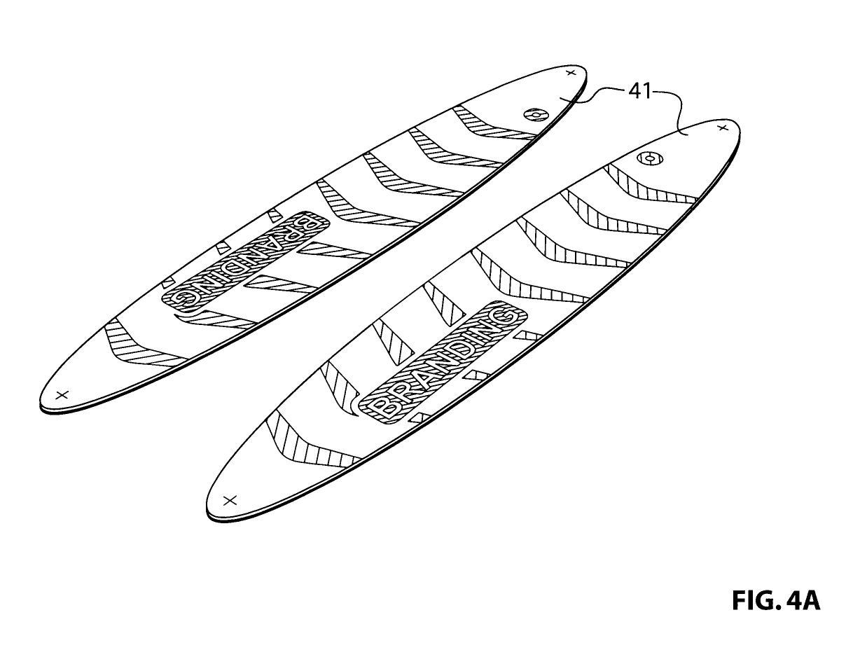

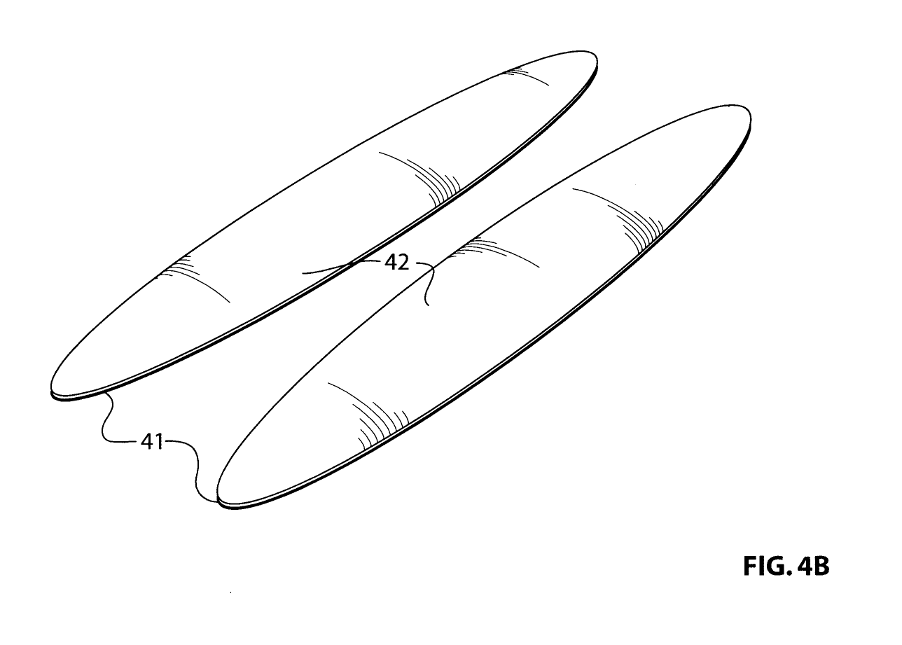

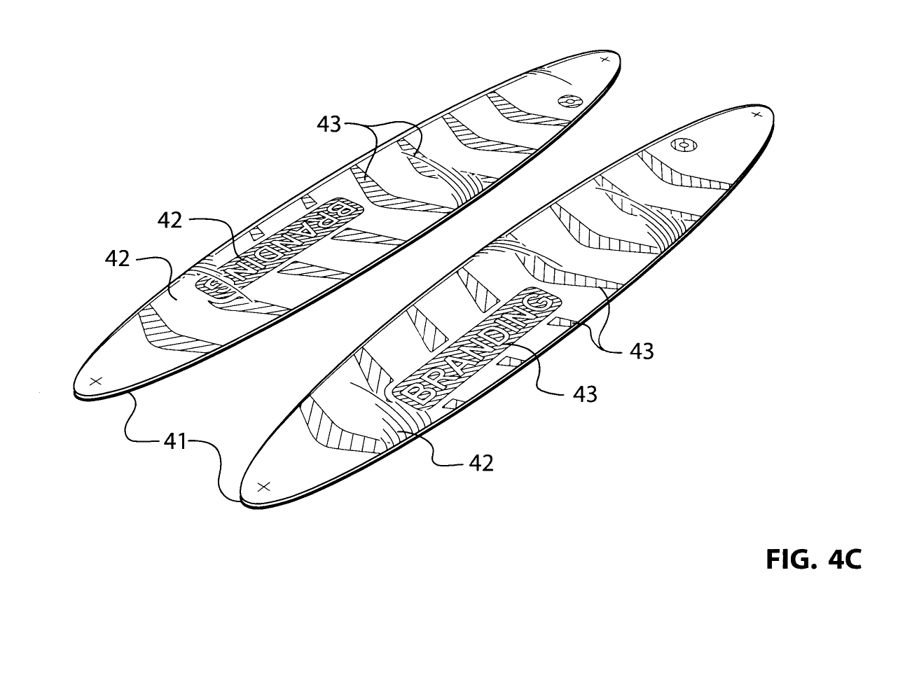

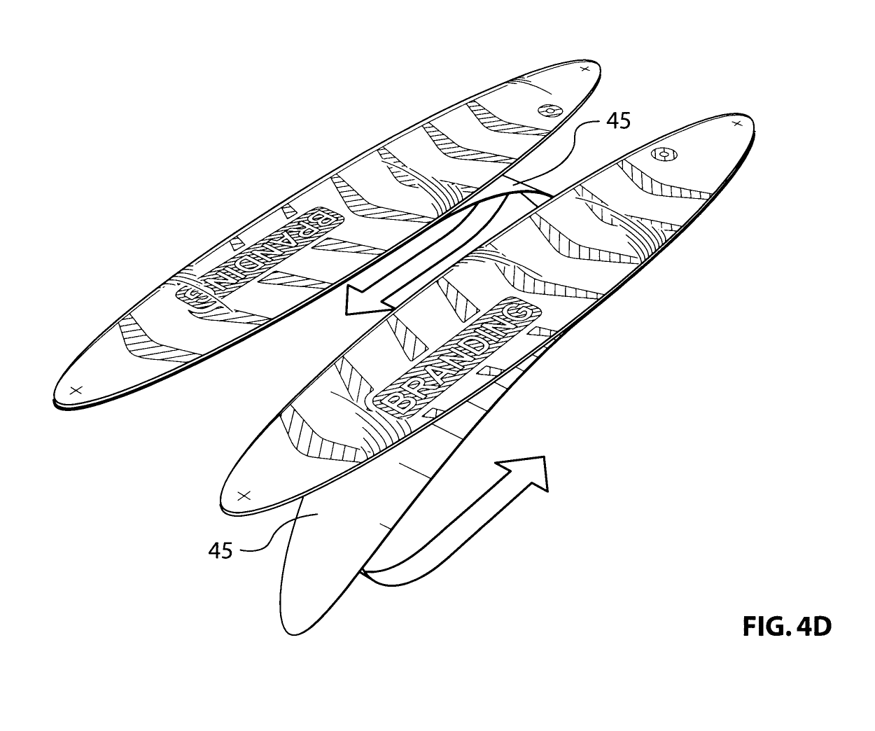

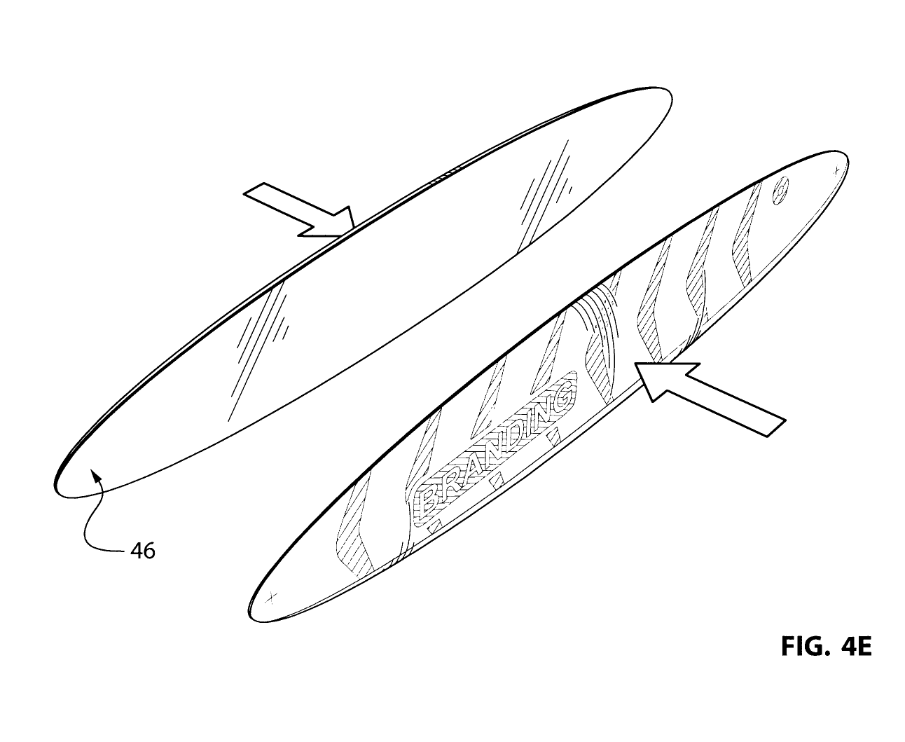

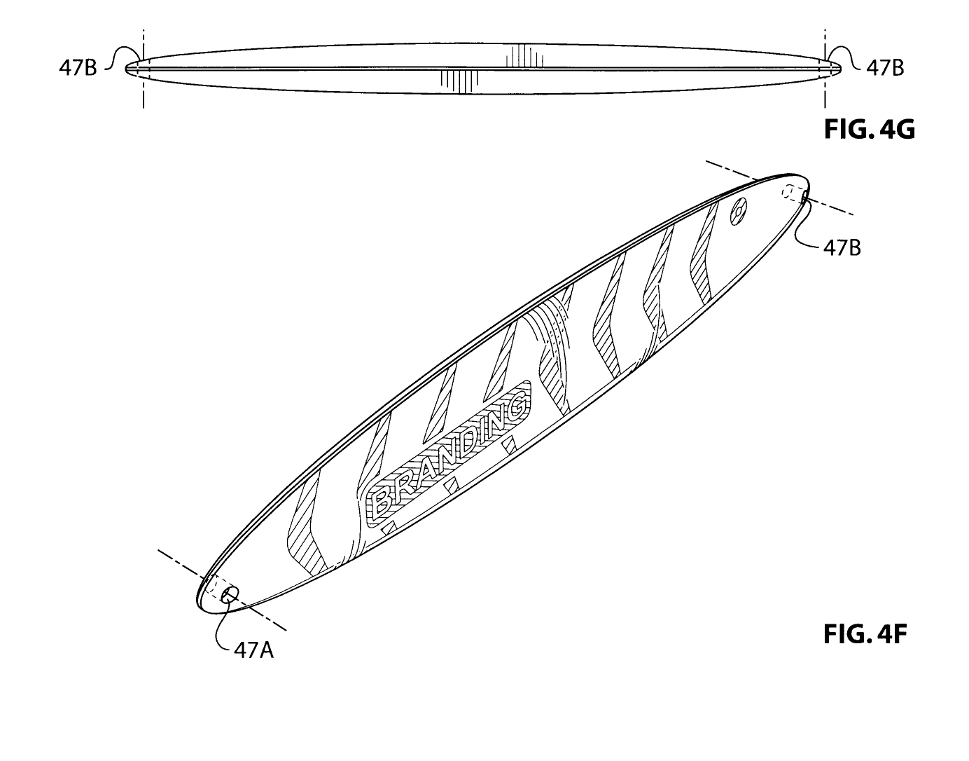

FIG. 4 illustrates a method 30 for making a lure according to an example embodiment. Method 30 begins at block 31 with providing labels which have the overall shape of body 12. The labels may comprise self-adhesive labels having an adhesive layer protected by a release sheet. Front surfaces of the adhesive labels may optionally be of a shiny material such as a foil or the like.

In block 32, indicia are applied on the front surfaces of the labels. FIG. 4A shows example self-adhesive labels 41 bearing various indicia.

Block 32 may be performed with a suitable printer such as a laser printer, an inkjet printer, a commercial printing press, or the like. The indica may, for example, comprise indicia that resemble a pattern of spots or other patterns resembling the skin of a fish, indicia having an appearance thought to appeal to fish (or to appeal to fisherman as being the sort of appearance that would appeal to fish). Applying the indicia may also comprise adhering objects, stickers, or the like to the labels.

The indicia may optionally include a branding such as the name or logo of a manufacturer or sponsor. The branding may include typed text or the like (for example, lure 12 may be made as a promotional item for a fishing lodge or other business in which case the name and contact information for the fishing lodge or other business may be printed onto the front surface of one or both labels in block 32).

In block 33, a flowable material having suitable characteristics to form layers 19 is applied, for example, by pouring, onto each of the labels until the material reaches the edge of the labels. The flowable material is allowed to form a domed shape under its surface tension. In block 33 the entire surface of both labels is preferably covered with the flowable material. The flowable material may, for example, comprise a two-part self-leveling epoxy. In some embodiments, the epoxy is an epoxy which is transparent, when cured. FIG. 4B shows labels 41 after layers 42 of uncured flowable material have been applied. One material that has been found to be satisfactory is a clear self-leveling two-part epoxy resin “bar top coating” having a resin component having a viscosity of 900 cps and a specific gravity of 1.15 and a hardener component having a viscosity of 100 cps and a specific gravity of 0.95. The hardener may be mixed with the resin in a ratio of 2 parts resin to one part hardener. The cured material has a heat deflection temperature of 120° F. A product having these characteristics is available as MIRRORCOAT™ self-leveling bar top coating from System Three Resins, Inc. of Auburn Wash. USA.

In block 34, the epoxy is allowed to cure. FIG. 4C shows labels 41 and layers 43 of cured material. The cured material is transparent so that indicia 33 can be seen through layers 43. In its cured form, the epoxy has a transition temperature or a transition range of temperatures above which it is malleable but below which it retains a form imparted to it when above the transition temperature. The transition temperature is preferably low enough that the lure can be handled with bare hands while body 12 is above the transition temperature. In some embodiments the transition temperature is below 90° C. and above 35° C.

In block 35, the labels are adhered back-to-back. Block 35 may, for example, comprise removing release sheets from the backs of the labels aligning the adhesive surfaces of the labels and sticking the two labels together to form body 12. This is illustrated in FIG. 4D which shows release sheets 45 being removed to reveal adhesive 46. FIG. 4E shows labels 41 being brought together in an aligned manner so that adhesive surfaces 46 band to one another. In other embodiments labels are adhered by applying a suitable adhesive to one or both labels and then adhering the labels to one another or applying a double-sided tape between the labels or the like.

In block 36, holes or other attachment points are formed to allow a leader and hook to be attached to body 12. FIGS. 4F and 4G show holes 47A and 47B formed at either end of the lure body.

Providing a sheet 18 is optional. In alternative embodiments, a body 12 can be made by shaping or forming the body 12 directly from a sheet of material that becomes malleable at warmer temperatures, as described above. For example, body 12 may comprise a sheet of plastic of a type that becomes malleable at a temperature above a transition temperature in the range of about 30° C. to 100° C.

Where a sheet 18 is provided, it is not necessary that the sheet be made of back-to-back self-adhesive labels. In some alternative embodiments, sheet 18 comprises sheets of paper, cardboard, plastic, or other suitable material and the sheets 18 are attached to one another through use of a suitable adhesive, plastic welding, or the like. Additionally, sheet 18 may comprise a single sheet of material in which a layer 19 on one side is applied first and after that first layer 19 has cured, another layer 18 may be applied on the opposing side of the body.

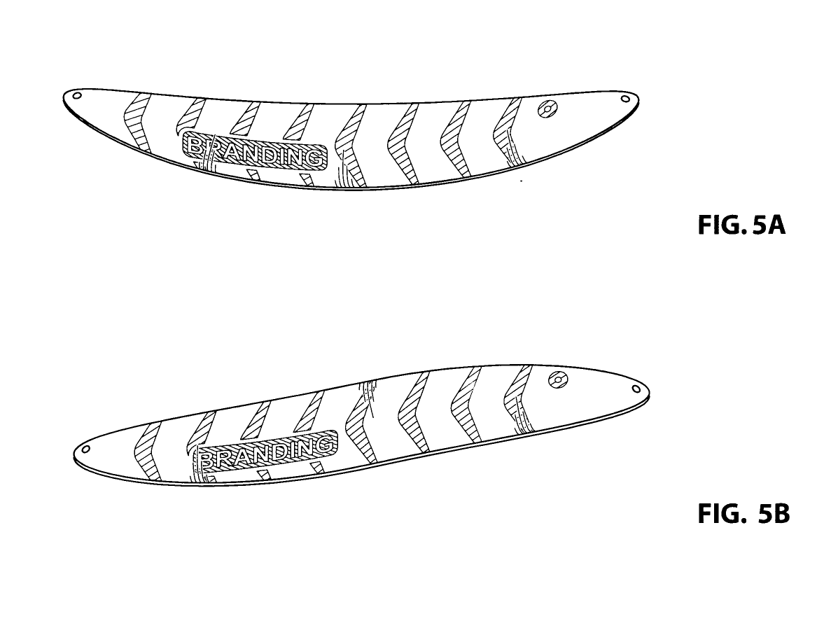

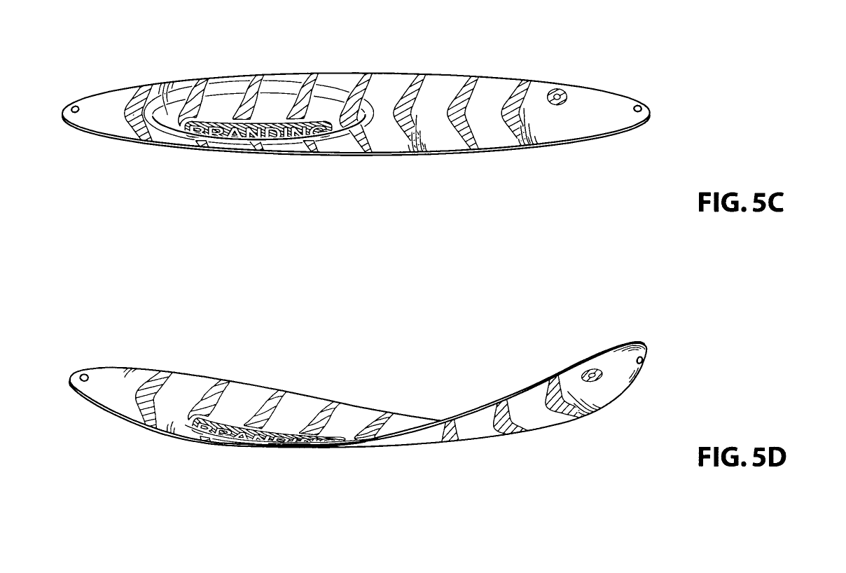

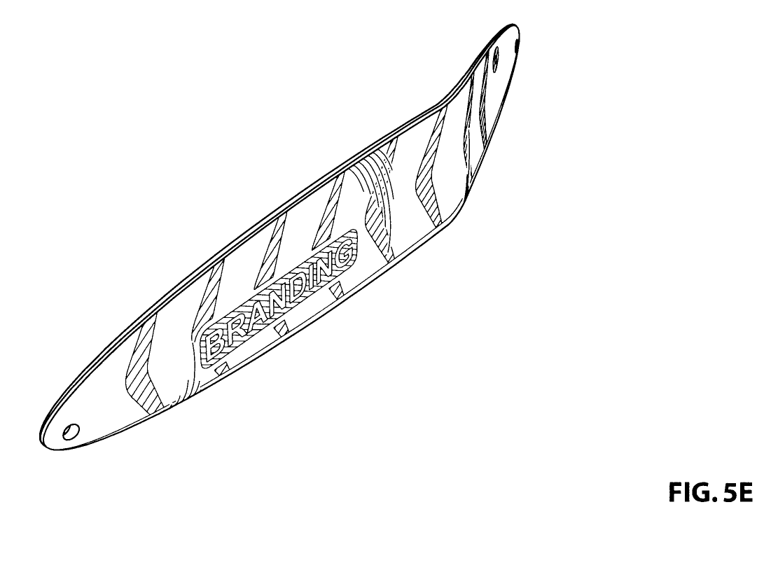

FIGS. 5A through 5E illustrate some example ways in which a lure body as described herein may be formed. FIG. 5A shows a lure body formed to have a simple curve. FIG. 5B shows a lure body formed to have an undulating curve which curves first one way and then another way. FIG. 5C shows a lure body which has been formed to provide a spoon-shape, on a portion thereof. FIG. 5D shows a lure body which has been formed to have a twist. FIG. 5E shows a lure body which has been formed to provide a relatively sharp bend.

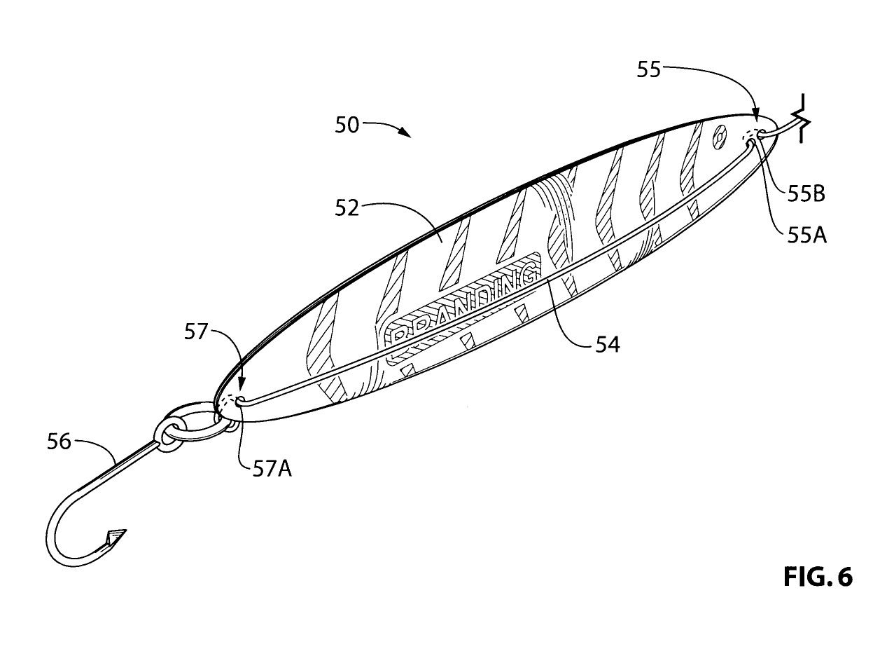

FIG. 6 illustrates a fish lure 50 according to an example embodiment of the invention. Fish lure 50 has a flattened body 52. Body 52 may be of construction similar to body 12 of lure 10 illustrated in FIG. 1, as described herein. Body 52 has a first attachment point 55 at one end of body 52 and a second attachment 57 at another end of body 52.

In the illustrated embodiment, attachment point 55 comprises closely spaced holes 55A and 55B, and attachment point 57 comprises a single hole 57A. A line 54 threaded through holes 55A, 55B and 57A is attached at one end to a hook 56. Line 54 may be attached to hook 56 by tying, for example.

A wide number of alternatives are possible in both the methods for making a lure and the construction of the lure. Some examples are:
Body 12 may have a wide range of shapes that are different from the shape illustrated. It is not mandatory that body 12 have a fish shape.
It is not necessary that body 12 have a single sharply defined transition temperature. The transition temperature may comprise a range of temperatures over which body 12 becomes malleable.

While a number of exemplary aspects and embodiments have been discussed above, those of skill in the art will recognize certain modifications, permutations, additions and sub-combinations thereof. It is therefore intended that the following appended claims and claims hereafter introduced are interpreted to include all such modifications, permutations, additions and sub-combinations as are within their true spirit and scope.

What is claimed is:

1. A fish lure comprising a flattened body comprising a thermo-formable material having a transition temperature in the range of 30° C. to 100° C. wherein the material is malleable at the transition temperature and holds its shape at temperatures below the transition temperature.

2. A fish lure according to claim 1 wherein the body comprises a sheet of a flexible material sandwiched between two layers of the thermo-formable material.

3. A fish lure according to claim 2 wherein the sheet comprises indicia on first and second major surfaces and the layers of the thermo-formable material are transparent so that the indica can be observed.

4. A fish lure according to claim 3 wherein first and second major surfaces of the sheet comprise a specularly-reflecting material.

5. A fish lure according to claim 4 comprising a first attachment point at one end of the body and a second attachment point at another end of the body.

6. A fish lure according to claim 5 wherein the body tapers in width and thickness towards the first and second ends.

7. A fish lure according to claim 6 wherein the attachment points comprise holes through the body.

8. A fish lure according to claim 1 wherein the body tapers in width and thickness toward first and second ends of the body.

9. A fish lure according to claim 2 wherein first and second major surfaces of the sheet comprise a specularly-reflecting material.

10. A fish lure according to claim 2 wherein the sheet comprises first and second labels adhered to one another.

11. A fish lure according to claim 2 wherein each of the layers of the thermo-formable material has a domed configuration and has rounded edges.

12. A fish lure according to claim 2 wherein the body has a thickness in the range of 1/16 inches to 3/16 inches.

13. A fish lure according to claim 2 wherein the thermo-formable material comprises epoxy resin.

14. A fish lure according to claim 1 wherein the transition temperature is in the range of 35° C. to 90° C.

15. A method for preparing a fish lure for use, the method comprising:
warming a body of the fish lure to a temperature above a transition temperature at which the body of the fish lure becomes malleable;
shaping the body of the fish lure by hand to have a desired configuration while the body remains above the transition temperature; and,
cooling the body of the fish lure to a temperature below the transition temperature such that the body retains the desired configuration.

16. A method according to claim 15 wherein the shaping comprises forming a bend in the body.

17. A method according to claim 15 wherein the shaping comprises forming a hollow in the body.

18. A method according to claim 15 wherein the temperature above the transition temperature is in the range of 30° C. to 100° C.

19. A method according to claim 18 wherein warming the body of the fish lure comprises placing the body of the fish lure in warm water.

20. A method for making a fish lure comprising:
providing first and second labels having front sides bearing indicia and rear sides, the first and second labels having shapes that are mirror images of one another;
forming a layer of a self-leveling curable flowable material onto each of the labels and allowing the flowable material to form a domed shape on each of the labels;
allowing the layers of flowable material to cure to provide a layer of thermo-formable transparent material on each of the labels, the thermo-formable material characterized by a transition temperature in the range of 30° C. to 100° C. above which the thermo-formable material is malleable; and,
adhering the backs of the labels to one another.
